(19) United States
(12) Patent Application Publication
(10) Pub. No.: US 2002/0044785 A1
(43) Pub. Date: Apr. 18, 2002

(54) Method and printing machine for applying a toner print to a printable surface, and measuring device for a printing machine

(75) Inventor: Wolfgang Luxem, Kiel (DE)

Correspondence Address: Lawrence P. Kessler, Patent Legal Staff, NexPress Solutions LLC, 343 State Street, Rochester, NY, 14650-2201, US

(73) Assignee: NexPress Solutions LLC

(21) Appl. No.: 09/929,723

(22) Filed: Aug. 14, 2001

(30) Foreign Application Priority Data
Oct. 13, 2000 (DE) 100 50 659.3

(51) Int. Cl. G03G 15/00

(52) U.S. Cl. 399/49

(57) ABSTRACT

A method is proposed for applying a toner print to a printable surface, in particular to a substrate (3), preferably paper or board, or to a transport surface for a substrate (3), as are a printing machine (1) and a measuring device (21) for implementing the method. Firstly, at least one print (7) is applied to the printable surface. Then, the amount of toner applied to the printable surface is measured by means of a measuring device (21). Finally, the difference between the actual amount of toner and a desired amount of toner in the print (7) applied to the printable surface is determined, the printing process being influenced on the basis of the deviation in such a way that the difference in the amounts of toner is reduced or at least remains the same during subsequent prints.

The invention relates to a method of applying a toner print to a printable surface, as claimed in claim 1, a printing machine for applying a toner print to a printable surface, according to the preamble of claim 7, and also a measuring device for a printing machine for determining the amount of toner applied to a printable surface, as claimed in claim 18.

In order to achieve a constant image quality in printing machines, it is necessary to control the printing process in such a way that the amount of toner in each case applied in the individual image areas results in the desired density and remains constant or substantially constant during continuous printing.

In known printing machines, in the unfixed state of the toner, when the latter, for example, is still on an image carrier, such as an image cylinder, the toner density is measured and the printing process is controlled with the aid of this value. In the event of high densities of the toner, the relationship between the measured toner density and the amount of toner transferred to the printable surface is no longer linear. As a result, in particular at high toner densities which result from a high amount of toner applied to individual image areas, precise control of the printing process is not possible in every case.

It is therefore an object of the invention to provide a method and a printing machine of the type mentioned at the beginning in which precise control or regulation of the amount of toner transferred to the printable surface can be ensured.

In order to achieve the object, a method having the features of claim 1 is proposed. Provision is made for at least one print to be applied to the printable surface, for example paper, board, plastic or the like. Then, with the aid of a measuring device, the amount of toner transferred to the printable surface is measured and the deviation between the amount of toner (ACT amount of toner) applied in the area of the print and a desired amount of toner (desired amount of toner in the print) is determined. The difference between the actual amount of toner and the desired amount of toner is used to influence the printing process, the influence being exerted in such a way that the amount of toner transferred to the substrate to form the print is reduced or increased as a function of the respective deviation, so that the difference between the ACT (actual) amount of toner and the DES (desired) amount of toner becomes smaller. If the difference between the ACT amount of toner and the DES amount of toner is within a specific tolerance band, reducing or increasing the amount of toner applied to the printable surface, and therefore exerting an influence on the control of the printing machine, is not required, so that the difference remains the same. The direct measurement of the amount of toner transferred to the printable surface permits very precise control of the printing process, even if the print exhibits high toner densities. In order to optimize the printing process and to increase the measuring sensitivity further, provision is made that, to measure the toner coverage in advance, that is to say the amount of toner transferred to the printable surface at a specific setting of the printing process or of the printing machine, first of all at least one test image is applied to a transport surface of a transport device for the substrate. Here, the term transport surface usually designates a part of a transport belt belonging to the transport device. As a result of applying the test image to the transport surface, the measurement step is independent of the condition of the substrate, for example moisture or thickness fluctuations. In addition, wastage of the substrate in the event of the wrong amounts of toner is avoided, since the printing of the substrate only begins when the difference between the ACT amount of toner and the DES amount of toner is within a specific tolerance band, that is to say has been controlled out to the desired extent.

In order to achieve the object, a printing machine which has the features of claim 7 is also proposed. It comprises a measuring device with the aid of which the amount of toner applied to the printable surface can be determined. By using the measuring device, exact determination of the amount of toner applied within an individual image area or within a print can be determined. This permits accurate control of the printing process, the measuring device being designed in such a way that the respective amount of toner in a print can be determined accurately, both in the case of low and in the case of high toner densities.

The subject of the invention also relates to a measuring device for determining the amount of toner applied to a printable surface, in particular to a substrate, preferably paper or board, or to a transport surface for a substrate, having the features of one or more of claims 7 to 17. The measuring device can therefore be employed in connection with a printing machine and is used to measure the amount of toner applied to a printable surface.

Advantageous exemplary embodiments emerge from the subclaims.

The shape and/or size of at least one test image is advantageously matched to the at least one electrode of the first, capacitive sensor. Since the toners for different colors can have different relative dielectric constant ε, at least one test image is preferably printed for each color and, for different amounts of toner, the characteristic curve “amount of toner per unit area in relation to the sensor output signal” from the sensor is determined. For mixed colors, the characteristic curve of the sensor can likewise be determined.

In a preferred embodiment, the measuring device has at least a first, capacitive sensor which, for example, is designed as a proximity switch or distance measuring device. The construction and function of the capacitive sensor are known in the literature, for example from “Induktive und kapazitive Sensoren” [Inductive and capacitive sensors] by Andreas Schiff, Verlag Modeme Industrie (1989) and “Sensortechnik” [Sensor engineering] by Harry Herold, Hüthig Verlag Heidelberg (1993), of which the content relating to the construction and the function of the capacitive sensor is made the subject of this application. In the case of these devices, which comprise a proximity switch or a distance measuring device, for example, the change in capacitance of a capacitor is measured. Given a constant electrode area, the capacitance may be changed by enlarging the distance between the two electrodes of the capacitor or by changing the effective relative dielectric constant ε of the medium between the electrodes. In a particularly preferred embodiment, the two capacitor plates are formed by the first, capacitive sensor and the measured object, in particular the printable surface with toner applied.

In an advantageous exemplary embodiment, provision is made for the first, capacitive sensor to be arranged in a fixed position at a distance from and opposite a transport surface of a transport device for the substrate. On the basis of this arrangement, the printable surface and the toner applied thereto, as they move through the interspace between the sensor and the transport surface on which the substrate rests, in each case effect a change in the relative dielectric constant ε of the medium between the capacitor plates (sensor and printable surface). This change effects a corresponding change in the sensor output signal and can be used to control the printing process. With the aid of the control system, the amount of toner in each case applied to the printable surface or the printable surfaces is increased or, if appropriate, reduced.

In order to carry out the measurement of the amount of toner on the printable surface, provision is made in a first exemplary embodiment for the toner to be fixed on the printable surface previously by, for example, being melted on in a known way. In another design variant, the measurement of the amount of toner is carried out with the toner transferred to the printable surface but in the unfixed state.

The aforementioned “measured object” is initially the transport surface which, for example, is formed by a transport belt. As soon as the print with a printable surface having a specific amount of toner passes into the interspace between the sensor and the transport surface, the “measured object” is formed by the printable surface. It remains to be recorded that, with the aid of the first, capacitive sensor, the distance between the sensor arranged in a fixed position and the printable and printed surface is measured. The amount of toner applied to the printable surface results in a specific toner density for the print having a constant area, the distance between the sensor and the printable surface becoming smaller as the toner density increases. In other words, the greater the amount of toner applied to an individual printing area, the higher the amount of toner projects beyond the surface of the printable surface, and the lower is the distance, measured with the aid of the capacitive sensor, between the sensor and the printable surface or the print.

In a preferred embodiment, the first, capacitive sensor is triggered in such a way that it measures the distance between itself and the measured object (transport surface or substrate) at the time at which the test image is located precisely under it or in the interspace bounded by the sensor and the transport surface. In order to control the first, capacitive sensor, signals from the existing control devices belonging to the printing machine, for example, can be used, which simplifies their construction.

The invention will be explained in more detail below using the drawings, in which:

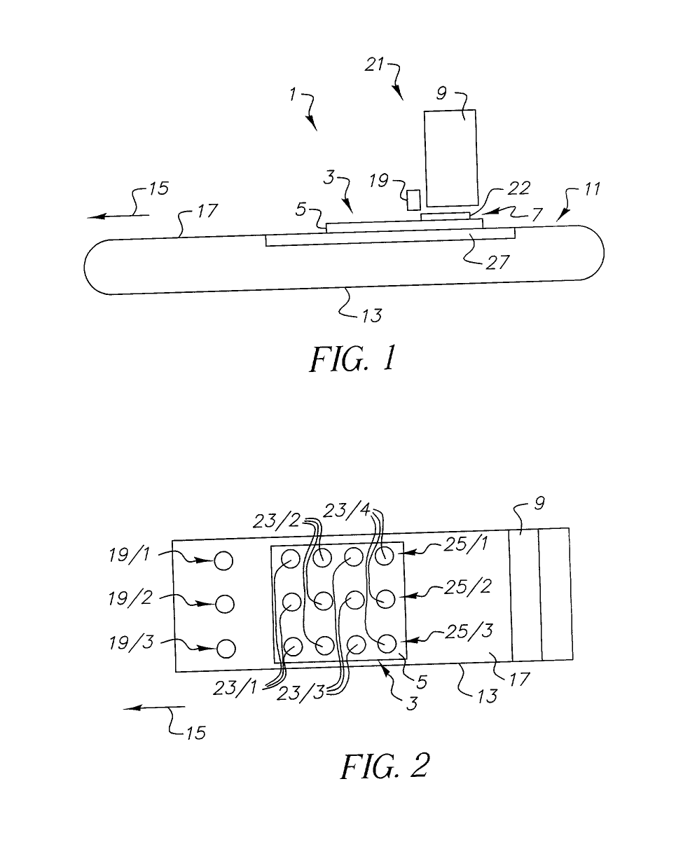

FIG. 1 shows a detail from a printing machine in the area of a printing unit in a schematic illustration,

FIG. 2 shows a plan view of the transport surface of a transport belt for conveying a substrate with test images applied to the substrate,

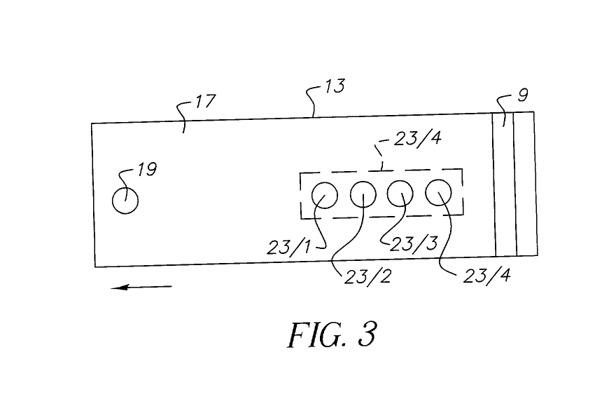

FIG. 3 shows a plan view similar to that of FIG. 2, the test images being applied to the transport surface.

FIG. 1 shows a detail of an exemplary embodiment of a printing machine 1 which can be employed generally, for example an electrophotographic printing machine, for applying liquid or powdered toner to a substrate 3, which is formed here, purely as an example, by a paper sheet 5. The construction and function of the printing machine are fundamentally known, for example from EP 0 786 705 A1 or EP 0 713 155 A2, so they will not be specifically discussed here.

The printing machine 1 has a plurality of printing units, with the aid of which in each case one print 7 in at least one specific color, for example black, yellow, magenta, cyan or a mixed color, is transferred to the substrate 3 in a known way. Of the printing units, only the printing unit 9 is illustrated schematically in FIG. 1.

Arranged underneath the printing unit 9 (arranged in a stationary position) is a transport device 11 which, in the exemplary embodiment illustrated in FIG. 1, has an endless transport belt 13 which can be displaced horizontally in the machine running direction 15 (arrow) with the aid of a drive device (not illustrated). The guidance of the transport belt 13 is chosen in such a way that, in the area of the printing unit 9 and in the areas upstream and downstream of the printing unit 9, it is guided at a distance from the latter.

The transport belt 13 has a transport surface 17 on which the substrate 3 to be printed with the aid of the printing unit 9 are deposited one behind the other in the machine running direction 15 and/or one beside the other over the width of the printing machine 1 and, by means of a displacement of the transport belt 13 underneath the printing unit 9, are guided past the latter. With the aid of the printing unit 9, a specific, adjustable amount of toner in the form of the print 7 is transferred to the substrate 3, which results in a specific toner density being established in the print 7.

Arranged downstream of the printing unit 9 in the machine running direction 15 is a first, capacitive sensor 19/1 to 19/3, which, as part of a measuring device 21 which is not specifically illustrated, is used to determine the amount of toner applied to the substrate 3. The first sensor 19/1 to 19/3 is arranged at a fixed distance with respect to the transport surface 17 of the transport belt 13. The capacitive sensor 19/1 to 19/3 is designed as a proximity switch or as a distance measuring device, whose functional principle is based on the fact that the capacitance change of a capacitor is measured. The two capacitor plates are formed here by the first sensor 19/1 to 19/3 and the measured object. Depending on the position of the substrate 3, the measured object is either the unprinted or printed transport surface 17 of the transport belt 13, as illustrated in FIG. 3, the substrate 3 in an unprinted area, as illustrated in FIG. 1, or the substrate 3 in the area of the print 7. Given a constant electrode area, the capacitance of the capacitor may be changed by enlarging the distance between the two electrodes, that is to say between the first sensor 19/1 to 19/3 and the measured object, or by changing the effective relative dielectric constant ε of the medium between the electrodes. As a result, it is possible to determine the amount of toner (ACT amount of toner) actually applied to the substrate for the print 7 of a specific area. The greater the amount of toner, the smaller is the distance between the print 7 and the first sensor 19/1 to 19/3, so that the measurement of the distance between the surface 22 of the print 7 and the first sensor 19/1 to 19/3 enables precise determination of the amount of toner and therefore also of the toner density of the print 7. Using a control device (not illustrated), for example the control device of the electrophotographic printing machine 1, the size of the difference between the actual amount of toner transferred to the substrate 3 and a desired, adjustable amount of toner (DES amount of toner), which ensures a specific toner density of the print 7, is then determined. Depending on the difference, the control of the electrophotographic process is changed in such a way that the deviation between the measured ACT amount of toner and the desired DES amount of toner becomes smaller or, if appropriate, remains the same. Because of the direct measurement of the amount of toner transferred to the substrate 3, the amount of toner transferred to the substrate 3 by the printing unit 9 is therefore adapted appropriately. In this way, a control loop can be implemented, which permits the automation of the process.

Of course, the measuring device 21 can also have a plurality of first sensors 19/1 to 19/3, which are arranged over the width of the printing machine 1, that is to say transversely over the width of the transport belt 13, distributed at a distance from one another (FIG. 2). In a further exemplary embodiment of the printing machine 1 (not illustrated), provision is made for at least a first capacitive sensor 19/1 to 19/3 to be arranged in each case downstream in the machine running direction 15 of each of the printing units of the printing machine 1. In order to reduce measurement errors which are caused by electrical charges and toner particles/residues on the transport surface 17 of the transport belt 13, an advantageous exemplary embodiment provides for the at least one first capacitive sensor 19/1 to 19/3 to be arranged, in the machine running direction 15, downstream of a treatment device (web-conditioning charger), not shown in FIG. 1, for the transport belt 13. With the aid of the treatment device, electrical charges and, if appropriate, dirt particles and toner residues are removed from the transport surface 17 before the measurement.

The measurement accuracy of the measuring device 21 or of the capacitive sensor 19/1 to 19/3 can, for example, be influenced by a different thickness of the transport belt 13, since fluctuations in the thickness of the transport belt 13 and its composition change the effective relative dielectric constant ε. In order to be able to take account of any thickness fluctuation in the transport belt 13 which may be present, the distance between the first sensor 19/1 to 19/3 arranged in a fixed position and the measured object can be measured at the time when only the transport belt 13 without a substrate 3 placed on it is located under the sensor 19/1 to 19/3. The measured values can be used for the purpose of correction.

The moisture of the paper sheet 5 exerts a further influence on the measurement accuracy of the measuring device 21. A comparative measurement between unprinted paper sheets and paper sheets with applied toner helps to reduce measurement errors here. A further possibility is to print at least one test image 23/1, 23/2, 2313, 23/4 directly onto the transport surface 17 of the transport belt 13, as shown in FIG. 3.

FIG. 2 shows a plan view of the transport surface 17 of the transport belt 13. Parts which have already been explained using FIG. 1 are provided with the same designations, so that to this extent reference is made to the description relating to FIG. 1. In this case, the test images 23/1, 23/2, 23/3, 23/4 are applied to the substrate 3, which lies on the transport belt 13, in each case three test images 23/1, 23/2, 23/3 and 23/4 being printed on for the colors black, yellow, magenta and cyan. The test images 23/1, 23/2, 23/3, 23/4 printed in one color in each case are distributed at a distance from one another over the width of the substrate 3, that is to say in each case a test image 23/1, 23/2, 23/3, 23/4 of a different color is located in a row—as seen in the machine running direction 15. Each of the rows of test images 25/1 to 25/3 is respectively assigned a first, capacitive sensor 19/1, 19/2 and 19/3 which, as indicated in FIG. 2, has at least one electrode with a cross section which is circular here. It becomes clear that the shape and size of the test images 23/1, 23/2, 23/3, 23/4 which are illustrated in FIG. 2 and arranged in a rectangular matrix is the same as the size and shape of the first, capacitive sensors 19/1 to 19/3. The size and/or shape of the test images 23/1, 23/2, 23/3, 23/4 and of the electrodes of the first, capacitive sensors 19/1 to 19/3 can be varied virtually as desired.

Since the toners for the various colors can have different relative dielectric constants c, in an advantageous design variant, a measurement of the amount of toner is carried out for each color and each mixed color, so that a characteristic curve of the amount of toner per unit area of the test image or the print 7 in relation to the sensor output signal from the sensors 19/1 to 19/3 can be determined.

The measuring sensitivity of the measuring device 21 can further be influenced by fluctuations in the distance between the transport belt 13 and the at least one capacitive sensor 19/1 to 19/3. In order to reduce the fluctuations in the distance, the transport belt 13 in the exemplary embodiment shown in FIG. 1 is guided on a special guide rail 27 underneath the sensor 19/1 to 19/3, which ensures flat contact with the transport belt 13. In this case, the guide rail 27 is of flat design and arranged horizontally. In another exemplary embodiment (not illustrated), it can also be curved.

A further reduction in the measurement error arising from distance fluctuations between the capacitive sensor 19/1 to 19/3 arranged in a fixed position and the transport belt 13 is achieved by the distance between the sensor 19/1 to 19/3 and the guide rail 27 being measured. This can be carried out, for example, by means of a second sensor (not illustrated), which can be formed by an inductive distance sensor in the case of a guide rail consisting of metal. Distance fluctuations, which can be caused by machine vibrations, for example, can be registered in this way and can be taken into account in measuring the amount of toner transferred to the printable surface.

In an advantageous exemplary embodiment, the first sensors 19/1 to 19/3 and the at least one second sensor are combined to form a sensor system which, for example, can form one structural unit.

It remains to be recorded that a capacitive sensor 19/1 to 19/3 or a plurality of capacitive sensors 19/1 to 19/3 can be arranged downstream of each of the printing units in the printing machine 1. In one exemplary embodiment, provision is made for a sensor 19/1 to 19/3 or a plurality of capacitive sensors 19/1 to 19/3 to be arranged only downstream of the last printing unit in the printing machine 1.

FIG. 3 shows a similar arrangement to that in FIG. 2, with the significant differences that the test image 23/1, 23/2, 23/3, 23/4 consists of only one row of test images 25.4, and the test image 23/1, 23/2, 23/3, 23/4 is applied directly to the transport surface 17. The measurement method corresponds to that described above, the capacitive sensor 19/1 to 19/3 registers the test images 23/1, 23/2, 23/3,23/4, which each contain toner of one color, one after another. The changing capacitance of the capacitive sensor 19/1 to 19/3 in the embodiment according to FIG. 3 is based in a similar way on the change in the distances between the capacitive sensor 19/1 to 19/3 and the transport surface 17, on the one hand, and the respective test image 23/1, 23/2, 23/3, 23/4, on the other hand.

The higher the toner is applied to the transport surface 17, that is to say the greater the amount of toner and the greater the amount by which the distance to the capacitive sensor 19/1 to 19/3 changes, the higher is the change in the capacitance. Using this variant, as compared with the others, a reliable measurement method is disclosed, the influences of the substrate 3 no longer interfere in the measurement and the measured results.

The method according to the invention readily emerges from the preceding explanations relating to FIGS. 1, 2 and 3.

List of Designations

1 Printing machine

3 Substrate

5 Paper sheet

7 Print

9 Printing unit

11 Transport device

13 Transport belt

15 Machine running direction

17 Transport surface

19 First sensor

21 Measuring device

22 Surface

23 Test image

25 Row of test images

27 Guide rail

1. A method of applying a toner print to a printable surface, in particular to a substrate (3), preferably paper or board, or to a transport surface (17) for a substrate (3), which comprises the following steps: applying the toner to the printable surface, measuring the amount of toner transferred to the printable surface by means of a measuring device (21), and influencing the printing process in such a way that the difference between the actual amount of toner and a desired amount of toner in the print applied to the printable surface is reduced or remains constant.

2. The method as claimed in claim 1, wherein the print contains at least one test image (23/1, 23/2, 23/3, 23/4), which is preferably applied to a transport surface (17) of a transport device (11) for the substrate (3).

3. The method as claimed in claim 1 or 2, wherein the shape and/or size of the test image is matched to the at least one electrode of a sensor (19; 19/1, 19/2, 19/3) used to measure the amount of toner.

4. The method as claimed in one of claims 1 to 3, wherein, for each color and, if appropriate, for each mixed color, at least one test image (23/1, 23/2, 23/3) is printed, the amount of toner applied is measured and, from this, the characteristic curve “amount of toner per unit area in relation to the sensor output signal” from the sensor (19; 19/1, 19/2, 19/3) is determined.

5. The method as claimed in one of the preceding claims, wherein the sensor (19; 19/1, 19/2, 19/3) is triggered in such a way that it measures at the time at which the print, preferably moving past it, is located opposite it.

6. The method as claimed in one of the preceding claims, wherein the sensor (19; 19/1, 19/2, 19/3) is a distance sensor, and wherein, the measurement of the amount of toner, a comparative measurement between an unprinted printable area and a printable area with applied toner is carried out.

7. A printing machine for applying a toner print to a printable surface, in particular to a substrate (3), preferably paper or board, or to a transport surface (17) for a substrate (3), in particular for implementing the method as claimed in one of the preceding claims 1 to 6, which comprises a measuring device (21) for determining the amount of toner applied to the printable surface.

8. The printing machine as claimed in claim 7, wherein the measuring device (21) has at least a first, capacitive sensor (19; 19/1, 19/2, 19/3), in particular a proximity switch or distance measuring device.

9. The printing machine as claimed in claim 7 or 8, wherein the first sensor (19; 19/1, 19/2, 19/3) is arranged opposite the transport surface (17) of a transport device (11) for the substrate (3), in particular in a fixed position.

10. The printing machine as claimed in one of claims 7 to 9, wherein the transport device (11) comprises at least one transport belt (13) which, at least in the area of the at least one sensor (19; 1911, 19/2, 19/3), is guided over at least one guide rail (27).

11. The printing machine as claimed in one of claims 7 to 10, wherein the at least two capacitor plates are formed by the first sensor (19; 19/1, 19/2, 19/3) and the measured object.

12. The printing machine as claimed in one of claims 7 to 11, wherein the at least one first sensor (19; 19/1, 19/2, 19/3)—as viewed in the transport direction of the printable surface—is arranged downstream of a printing unit (9) and/or a treatment device for the transport surface (17).

13. The printing machine as claimed in one of claims 7 to 12, wherein a plurality of first sensors (19; 19/1, 19/2, 19/3) are provided, of which in each case at least one is arranged downstream of a printing unit (9)—as viewed in the transport direction of the printable surface.

14. The printing machine as claimed in one of claims 7 to 13, wherein a plurality of first sensors (19; 19/1, 19/2, 19/3) are arranged over the width of the printing machine (1), preferably at a distance from one another.

15. The printing machine as claimed in one of claims 1 to 14, wherein the measuring device (21) comprises at least a second sensor which is arranged in a fixed position and which is used to determine the distance between itself and the guide rail (27).

16. The printing machine as claimed in one of claims 1 to 15, wherein the second sensor is an inductive distance sensor.

17. The printing machine as claimed in one of claims 1 to 16, wherein the first and second sensors are combined to form a sensor system.

18. A measuring device (21) for determining the amount of toner applied to a printable surface, in particular to a substrate (3), preferably paper or board, or to a transport surface (17) for a substrate (3).
